(19) United States
(12) Patent Application Publication
(10) Pub. No.: US 2006/0227759 A1
(43) Pub. Date: Oct. 12, 2006

(54) Peripheral Sharing USB Hub

(76) Inventors: Mark R. Bohm, Village of Bear Creek, TX (US); Mark Y. Fu, Newark, CA (US); Henry Wurzburg, Austin, TX (US); James E. Bowles, Austin, TX (US); Robert E. Hollingsworth, Smithtown, NY (US); Drew J. Dutton, Austin, TX (US); Akhlesh Nigam, Austin, TX (US)

Correspondence Address: MEYERTONS, HOOD, KIVLIN, KOWERT & GOETZEL, P.C., 700 LAVACA, SUITE 800, AUSTIN, TX, 78701, US

(21) Appl. No.: 11/424,179

(22) Filed: Jun. 14, 2006

Related U.S. Application Data
(63) Continuation-in-part of application No. 11/100,299, filed on Apr. 6, 2005.
Application No. 11/100,299 is a continuation-in-part of application No. 10/940,406, filed on Sep. 14, 2004.

(51) Int. Cl. H04L 12/28; H04L 12/56

(52) U.S. Cl. 370/351; 370/401

(57) ABSTRACT

In various embodiments, devices coupled to upstream ports may enumerate the USB switching hub according to the total number of downstream ports on the USB switching hub. In some embodiments, when a first upstream port is communicating with a first downstream port, status registers coupled to the second upstream port may indicate to the second upstream device that the first downstream port is disconnected. By enumerating the USB switching hub according to the total number of downstream ports, the upstream devices may not have to re-enumerate the hub (and correspondingly each device coupled to the hub) each time a downstream device is switched. In some embodiments, an intelligent port routing switch may delay switching communications for the downstream port if there is an active transfer in progress between a related downstream port and an upstream port.

### PRIORITY

This application is a continuation-in-part of U.S. patent application Ser. No. 11/100,299 titled “Peripheral Sharing USB Hub” filed on Apr. 06, 2005, whose inventors are mark R. Bohm, Mark Fu, Henry Wurzburg, James E. Bowles, Robert E. Hollingsworth, and Drew J. Dutton, which is a continuation-in-part of U.S. patent application Ser. No. 10/940,406 titled “Universal Serial Bus Switching Hub” filed on Sep. 14, 2004, whose inventors are Henry Wurzburg, James E. Bowles, Robert E. Hollingsworth, Mark R. Bohm, and Drew J. Dutton. U.S. patent application Ser. No. 11/100,299 and U.S. patent application Ser. No. 10/940,406 are both hereby incorporated by reference as though fully and completely set forth herein.

### BACKGROUND OF THE INVENTION

1. Field of the Invention

The present invention relates generally to computer hardware and, more specifically, to Universal Serial Bus (USB) switching hubs.

2. Description of the Related Art

The Universal Serial Bus (USB) allows coupling of peripheral devices to a computer system. USB is a serial cable bus for data exchange between a host computer and a wide range of simultaneously accessible devices. The bus allows peripherals to be attached, configured, used, and detached while the host is in operation. For example, USB printers, scanners, digital cameras, storage devices, card readers, etc. may communicate with a host computer system over USB. USB based systems may require that a USB host controller be present in the host system, and that the operating system (OS) of the host system support USB and USB Mass Storage Class Devices.

USB devices may communicate over the USB bus at low-speed (LS), full-speed (FS), or high-speed (HS). A connection between the USB device and the host may include four wires (a power line, a ground line, and a pair of data lines (D+ and D−). When a USB device connects to the host, the USB device may first pull a D+ line high (the D− line if the device is a low speed device) using a pull up resistor on the D+ line. The host may respond by resetting the USB device. If the USB device is a high-speed USB device, the USB device may “chirp” by driving the D− line high during the reset. The host may respond to the “chirp” by alternately driving the D+ and D− lines high. The USB device may then electronically remove the pull up resistor and continue communicating at high speed. When disconnecting, full-speed devices may remove the pull up resistor from the D+ line (i.e., “tri-state” the line), while high-speed USB devices may tri-state both the D+ and D− lines.

A USB hub may be coupled to a USB host controller to allow multiple USB devices to be coupled to the host system through the USB host controller. In addition, other USB hubs may be coupled to the USB hub to provide additional USB device connections to the USB host controller.

Some dual role peripheral devices may include a slave controller and be capable of communicating with other peripheral devices coupled to them. For example, a dual role USB printer may be able to communicate directly with a USB camera to print pictures from the USB camera. The dual role USB printer may also be accessible (e.g., by a computer system) as a slave peripheral device. If a computer system and dual role peripheral device need to alternately access a peripheral device, the peripheral device may need to be unplugged from one device and coupled to the other. Prior art device switches may not work for high-speed peripheral devices. For example, mechanical switches may introduce too much capacitance or inductance to work with high-speed peripheral devices. High-speed peripheral devices also typically require smooth impedance to prevent ringing (mechanical switches introduce irregularities in the impedance that may cause ringing).

### SUMMARY OF THE INVENTION

In various embodiments, devices coupled to upstream ports of a USB switching hub may enumerate the USB switching hub according to the total number of downstream ports on the USB switching hub. In some embodiments, communications between each of the downstream ports and the upstream ports may be controlled by the USB switching hub. In some embodiments, when a first upstream port is communicating with a first downstream port, a second upstream port may perceive the first downstream port as disconnected. For example, status registers coupled to the second upstream port may indicate the first downstream port is disconnected (i.e., to appear that no device is electrically connected to the first downstream port). The disconnect status may prevent the second upstream device from attempting to reset and connect to a downstream device coupled to the first downstream port while a separate upstream device is communicating through the first upstream port with the first downstream device. By enumerating the USB switching hub according to the total number of downstream ports, the upstream devices may not have to re-enumerate the hub (and correspondingly each device coupled to the hub) each time a downstream device is switched.

In some embodiments, an intelligent port routing switch (IPRS) may delay switching communications for the downstream port if there is an active transfer in progress between the downstream port and the first upstream port. In some embodiments, the IPRS may delay switching communications for the downstream port if there is an active transfer in progress between a downstream port and the second upstream port.

The IPRS may delay switching communications between other downstream ports if there are other pending or active transfers in progress. In some embodiments, the IPRS may monitor communications at the hub controller level or may monitor communications at the downstream switching logic level. Other placements between the downstream ports and the upstream ports may also be used. In some embodiments, instead of relying on intelligent monitoring or an external method for delaying switching communications, switching may be delayed to take place at the USB frame boundary (when, by definition, no traffic is permitted to be in progress). Switching, in these embodiments, may be delayed until the frame boundary on a predetermined basis, not as a result of intelligent monitoring.

### BRIEF DESCRIPTION OF THE DRAWINGS

A better understanding of the present invention may be obtained when the following detailed description is considered in conjunction with the following drawings, in which:

FIG. 1 illustrates a USB switching hub, according to an embodiment;

FIG. 2 illustrates a computer system coupled to a USB switching hub, according to an embodiment;

FIG. 3 illustrates a computer system and a dual role peripheral device coupled to a USB switching hub, according to an embodiment;

FIGS. 4a and 4b illustrate two communication configurations of the USB switching hub, according to an embodiment;

FIGS. 5a, 5b, and 5c illustrate additional communication configurations of the USB switching hub, according to an embodiment;

FIG. 6 illustrates unified functions within the USB switching hub, according to an embodiment;

FIG. 7 illustrates a method for switching access to a downstream port between two upstream ports, according to an embodiment;

FIG. 8 illustrates a USB switching hub with multiple status registers, according to an embodiment;

FIG. 9 shows a method for switching access to a downstream port between two upstream ports without reenumerating the USB switching hub, according to an embodiment;

FIG. 10 shows a method for monitoring a standby state to approve a communication switch, according to an embodiment;

FIG. 11 shows a method for monitoring hub transactions to approve a communication switch, according to an embodiment;

FIG. 12 shows a method for switching communications at a frame boundary, according to an embodiment;

FIG. 13 illustrates a computer system and a dual role peripheral device coupled to a USB switching hub, according to an alternate embodiment;

FIGS. 14a and 14b illustrate two communication configurations of the USB switching hub, according to an alternate embodiment;

FIGS. 15a, 15b, and 15c illustrate additional communication configurations of the USB switching hub, according to an alternate embodiment;

FIG. 16 illustrates a USB switching hub with multiple status registers, according to an alternate embodiment; and

FIG. 17 illustrates an alternate embodiment of a computer system and a peripheral device coupled to a USB switching hub.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (e.g., having the potential to or being able to in some embodiments), not a mandatory sense (i.e., must). The term “include”, and derivations thereof, mean “including, but not limited to”. The term “coupled” means “directly or indirectly connected”.

### DETAILED DESCRIPTION OF EMBODIMENTS OF THE INVENTION

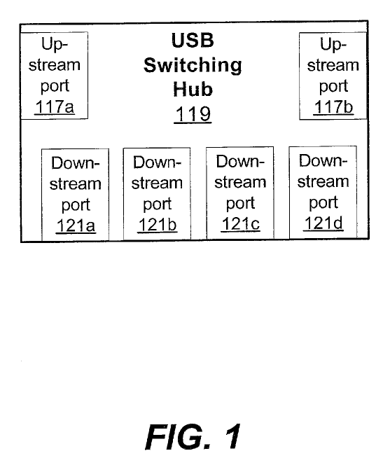

FIG. 1 illustrates an embodiment of a USB switching hub. In various embodiments, USB switching hub 119 may control access between two or more upstream ports 117 on USB switching hub 119 and at least a subset of downstream ports 121 on USB switching hub 119.

In some embodiments, upstream devices coupled to upstream ports 117 may enumerate USB switching hub 119 according to the total number (N) of downstream ports 121. For example, USB switching hub 119 may be enumerated as a 4-port hub (corresponding to the four downstream ports 121). In some embodiments, communications between each of downstream ports 121 and upstream ports 117 may be controlled by USB switching hub 119. In some embodiments, when first upstream port 117a is communicating with first downstream port 121a, second downstream port 121b may communicate with second downstream port 121c. Second upstream port 117b may register first downstream port 121a as disconnected. For example, status registers coupled to second upstream port 117b may indicate first downstream port 121a is disconnected (i.e., to appear that no device is electrically connected to first downstream port 121a). The disconnect status may prevent second upstream device 117b from attempting to reset and connect to first peripheral device 121a coupled to first downstream device 121a while a separate upstream device is communicating through first upstream port 117a with first downstream device 125a. By enumerating USB switching hub 119 as a 4-port hub, the upstream devices may not have to re-enumerate USB switching hub 119 (and correspondingly each downstream and/or upstream device coupled to the USB switching hub) each time a downstream device is switched.

In some embodiments, only one upstream device may access any one downstream device at a time. In some embodiments, multiple upstream devices may access separate downstream devices at the same time. In some embodiments, different communication configurations may be implemented. For example, first upstream port 117a may be allowed access to the first three downstream ports (121a, 121b, and 121c) and second upstream port 117b may be allowed access to fourth downstream port 121d. Devices coupled to first upstream port 117a and second upstream port 117b may have enumerated USB switching hub 119 as a 4-port hub, but in this example, a device coupled to first upstream port 117a may register fourth downstream port 121d as disconnected while a device coupled to second upstream port 117b may register the first three downstream ports (121a, 121b, and 121c) as disconnected.

In a second communication configuration, first upstream port 117a may be allowed to access fourth downstream port 121d while second upstream port 117b may be allowed to access the first three downstream ports (121a, 121b, and 121c). Other communication configurations are also possible (e.g., in one communication configuration neither upstream port 117 may be allowed to access any downstream port 121). In some embodiments, USB switching hub 119, after receiving a control signal (e.g., from a computer, a different attached device, a person, a sensor, a logic internal to USB switching hub 119, etc.), may switch between the first communication configuration and the second communication configuration (or another communication configuration). In some embodiments, USB switching hub 119 may not receive a control signal before switching communication configurations (e.g., switching access for first downstream device 125a from first upstream port 117a to second upstream port 117b).

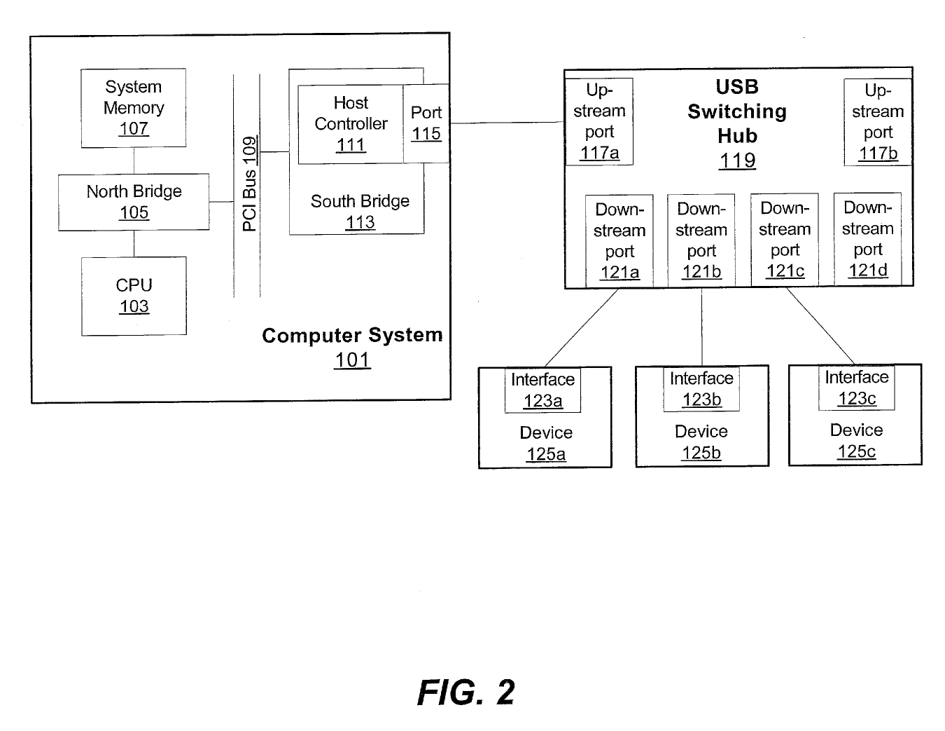

FIG. 2 illustrates an embodiment of computer system 101 coupled to USB switching hub 119. In some embodiments, computer system 101 (e.g., a personal computer (PC), laptop, server, etc.) may access multiple peripheral devices 125 coupled to USB switching hub 119. Computer system 101 may couple to USB switching hub 119 through upstream port 117. Computer system 101 may receive and transmit signals, e.g., USB signals, through host controller 111 coupled to device port 115. While various embodiments may include computer system 101, it is to be understood that other devices that have a host controller may also access USB switching hub 119. Host controller 111, coupled to south bridge 113, may be coupled to other computer components (e.g., north bridge 105, central processing unit (CPU) 103, and system memory 107) through peripheral component interconnect (PCI) bus 109.

In some embodiments, USB switching hub 119 may have multiple downstream ports 121 for coupling to multiple peripheral devices 125. Peripheral devices 125 may include USB printers, scanners, digital cameras, digital camera docks, consumer audio/video, storage devices, and card readers, among others. In some embodiments, peripheral devices 125 may couple to USB switching hub 119 through interface 123. In some embodiments, interface 123 may be a PHY interface. Other interfaces may also be used (e.g., UTMI or ULPI). Upstream ports 117 and downstream ports 121 may also have interfaces.

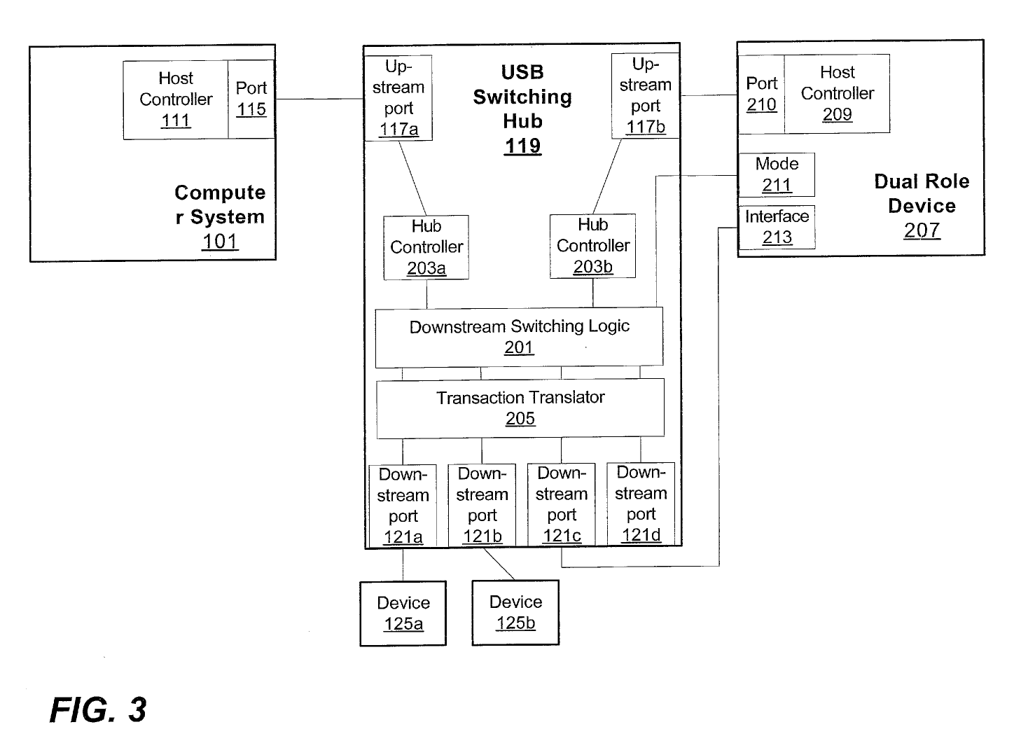

FIG. 3 illustrates an embodiment of two upstream devices (e.g., computer system 101 and dual role peripheral device 207) coupled to USB switching hub 119. In some embodiments, USB switching hub 119 may include downstream switching logic 201, coupled to one or more hub controllers 203 (e.g., hub controllers 203a and 203b). Downstream switching logic 201 may also be coupled to transaction translator circuitry 205. Transaction translator 205 may be electronically coupled to downstream ports 121. In some embodiments, downstream switching logic 201 may switch between two or more communication configurations. Communication configurations may be implemented by downstream switching logic 201 routing communications between upstream ports 117 and downstream ports 121 while the communications are in the digital domain (as a result of the interfaces to/from USB switching hub 119). In some embodiments, communication configurations (e.g., hardwired in the USB switching hub) may be switched as determined by logic on the USB switching hub. Other communication configuration implementations are also contemplated.

In some embodiments, dual role peripheral device 207 may include a dual role USB printer or dual role USB Digital Versatile Disc (DVD) read/write drive, among others. In some embodiments, dual role peripheral device 207 may be coupled to an upstream port (e.g., upstream port 117b) of USB switching hub 119 through device port 210. Dual role peripheral device 207 may interface through upstream port 117b with other peripheral devices (downstream peripheral devices) coupled to USB switching hub 119 (e.g., using host controller 209 on dual role peripheral device 207). Dual role peripheral device 207 may also interface with other upstream devices (such as computer system 101) through a slave controller. For example, dual role peripheral device 207 may be coupled to USB switching hub 119 as a slave peripheral device (e.g., through downstream port 121c). In some embodiments, dual role peripheral device 207, coupled to the USB switching hub, may simultaneously act as a host to one or more peripheral devices and/or as slave peripheral device to a separate host.

In some embodiments, dual role peripheral device 207 may have an embedded host controller application to operate as a standalone system (e.g., to communicate with another peripheral device, such as a digital camera, without PC intervention). For example, a dual role USB printer may print pictures directly from a digital camera, coupled to a downstream port 121 on USB switching hub 119, without PC intervention. In some embodiments, USB switching hub 119 may alternately allow the computer system 101 or dual role peripheral device 207 to access one or more downstream devices (e.g., by switching between one or more communication configurations).

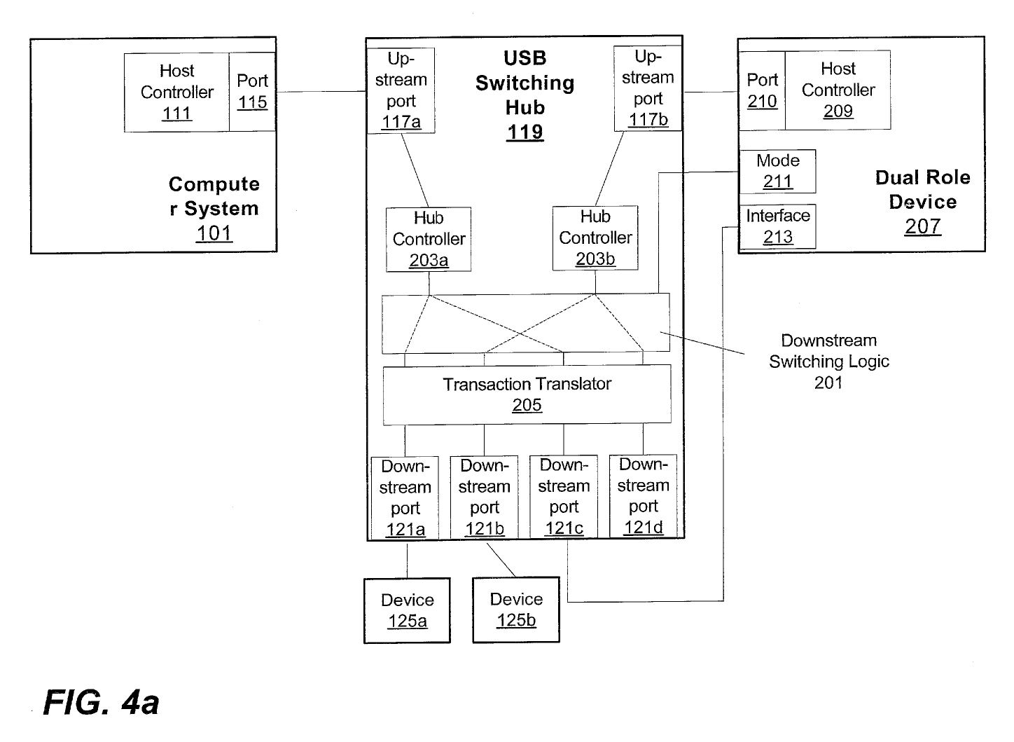

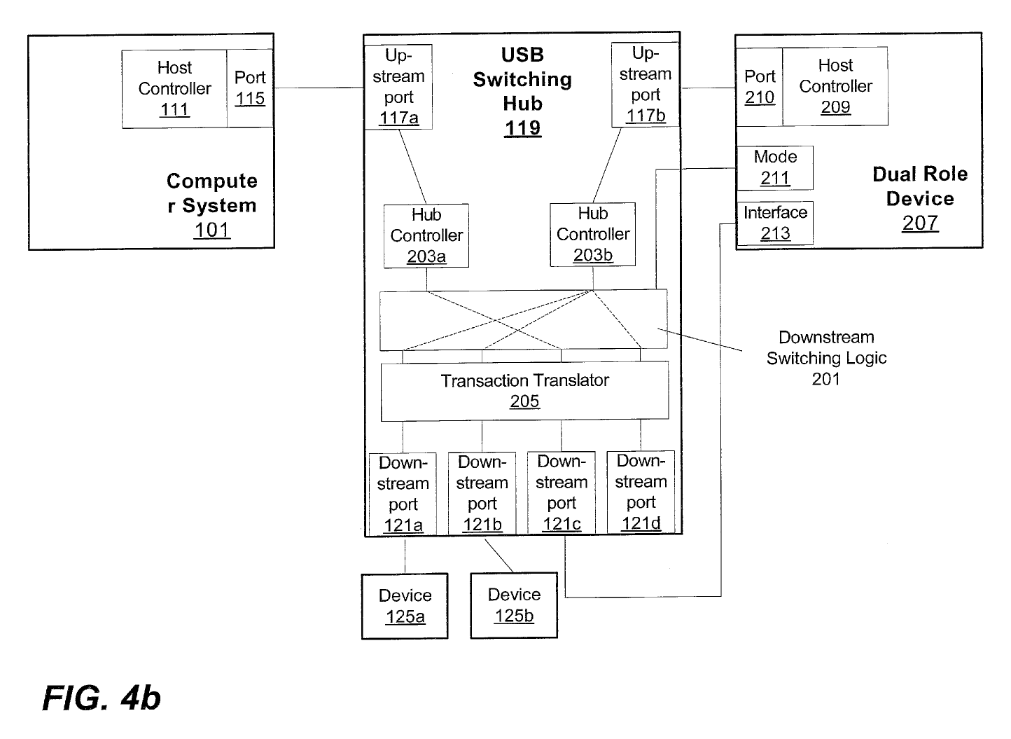

FIG. 4a illustrates an embodiment of a computer system electronically coupled to multiple peripheral devices. In some embodiments, USB switching hub 119 may act like a switch coupling multiple internal “hubs” that may share one or more downstream ports. For example, each potential communication configuration of the USB switching hub may represent an internal “hub”. In some embodiments, when computer system 101 is accessing peripheral device 125 (e.g., peripheral device 125a) coupled to USB switching hub 119, communications to/from the peripheral device may be processed through a first “hub” comprised of first upstream port 117a, hub controller 203a, transaction translator 205, and at least a subset of the downstream ports 121. A second “hub” may be comprised of second upstream port 117b, hub controller 203b, transaction translator 205, and at least a subset of the downstream ports 121. In one communication configuration, computer system 101 may connect to downstream ports 121a and 121c (through the first “hub”), and dual role peripheral device 207 may connect to downstream ports 121b and 121d (through the second “hub”) (as seen in FIG. 4b). Other communication configurations are also contemplated. In some embodiments, communication configuration profiles designating which downstream devices to couple to each upstream port may be hardwired or implemented by software. For example, if implemented by software, communication configuration profiles for each upstream port (and/or upstream device) may be stored on a memory accessible to USB switching hub 119.

In some embodiments, computer system 101 and dual role peripheral device 125 may communicate through USB switching hub 119 simultaneously with separate downstream devices. For example, while computer system 101 communicates with device 125a (e.g., through the first “hub”), dual role peripheral device 207 may communicate with device 125b (e.g., through the second “hub”). In some embodiments, while peripheral device 125a is being accessed through the first “hub”, a different upstream device may not be able to access peripheral device 125a (e.g., dual role peripheral device 207 may not be able to access peripheral device 125a while peripheral device 125a is being used by computer system 101). In some embodiments, a signal (e.g., from an external control block) may trigger downstream switching logic 201 to switch access for a subset of downstream ports 121 (e.g., downstream port 121a and/or 121c) on the first “hub” to the second “hub” (i.e., switch communication configurations). In some embodiments, dual role peripheral device 207 may send a control signal to USB switching hub 119. USB switching hub 119 may then switch communication configurations to connect one or more downstream ports to the dual role peripheral device. For example, when a user presses a button on dual role peripheral device 207 (e.g., a dual role printer), a signal may be sent through mode 211 to downstream switching logic 201 to switch access of device 125a from computer system 101 to dual role peripheral device 207 (i.e., to switch to a second communication configuration as seen in FIG. 4b). Computer system 101 may continue to communicate with downstream port 121c (and/or other downstream ports as determined by the second communication configuration).

In some embodiments, when activity is no longer detected between dual role peripheral device 207 and a downstream port (e.g., if dual role peripheral device 207 is turned off), downstream switching logic 201 may switch access of the downstream port to computer system 101 (i.e., switch to a different communication configuration). In some embodiments, downstream switching logic 201 may switch access of the downstream port to a different upstream device. In some embodiments, instead of detecting inactivity, a signal from dual role peripheral device 207 may signal USB switching hub 119 to switch. Other signals and/or logic may also be used in determining when to switch communication configurations.

In some embodiments, communication configurations may be software implemented. In some embodiments, a microprocessor coupled to or comprised in downstream switching logic 201 may dynamically determine, e.g., using a dynamic communication configuration profile, which downstream ports to electrically couple to each upstream port. For example, the microprocessor may read a stored communication configuration profile and attempt to connect upstream ports to downstream ports according to the communication configuration profile. The communication configuration profiles may be stored on a memory (e.g., an Electronically Erasable Programmable Read-Only Memory (EEPROM)) coupled to USB switching hub 119. In some embodiments, hub controllers 203 on USB switching hub 119 may have access to the communication configuration profiles.

In some embodiments, a priority logic may be used to switch communication configurations. Priority logic, or other logic used to grant access, may be internal or external to USB switching hub 119. In some embodiments, computer system 101 may be given priority over all of downstream ports 121 until an external control signal is sent from dual role peripheral device 207 to switch access of one or more downstream ports 121 to dual role peripheral device 207. In some embodiments, different control signals may be sent to trigger different communication configurations (i.e., to switch access of different downstream ports to dual role peripheral device 207).

In some embodiments, host negotiation logic may be used to determine which communication configuration to use. In some embodiments, a default communication configuration may be used until multiple upstream devices “request” access to the same downstream port. Host negotiation logic may be used to determine which communication configuration to use (i.e., which communication configuration gives a particular upstream port access to the “requested” downstream port).

In some embodiments, a microprocessor in USB switching hub 119 may include a built in algorithm that auto detects downstream peripheral devices and determines how to connect the downstream peripheral devices. For example, instead of assigning a specific downstream port to an upstream port, a communication configuration profile may specify that the upstream port should have access to a digital camera if one is attached. The built in algorithm may auto-detect the digital camera when it is attached to one of the downstream ports and attach it to the appropriate upstream port (i.e., by switching to an appropriate communication configuration).

In some embodiments, when downstream switching logic 201 switches communication configurations, and control of a downstream port is switched from computer system 101 to dual role peripheral device 207, a connection between computer system 101 and respective peripheral device 125 (coupled to the downstream port to be switched) may be terminated by computer system 101. In some embodiments, communications between the downstream port to be switched and computer system 101 may be terminated by USB switching hub 119. Dual role peripheral device 207 may then connect to, enumerate, and communicate with the respective peripheral device 125 coupled to the switched downstream port.

Upstream devices may see downstream ports that they are not configured to attach to as unattached ports (i.e., active, but with no device connected). In some embodiments, if only a predetermined number of downstream ports is ever going to be attached to a particular upstream port (e.g., a number “x” ports), the upstream device may be signaled that the hub only has x ports. For example, if upstream port 117b is only going to be configured to attach to downstream ports 121c and 121d, a device attached to upstream port 117b may be signaled that USB switching hub 119 is only a two port hub.

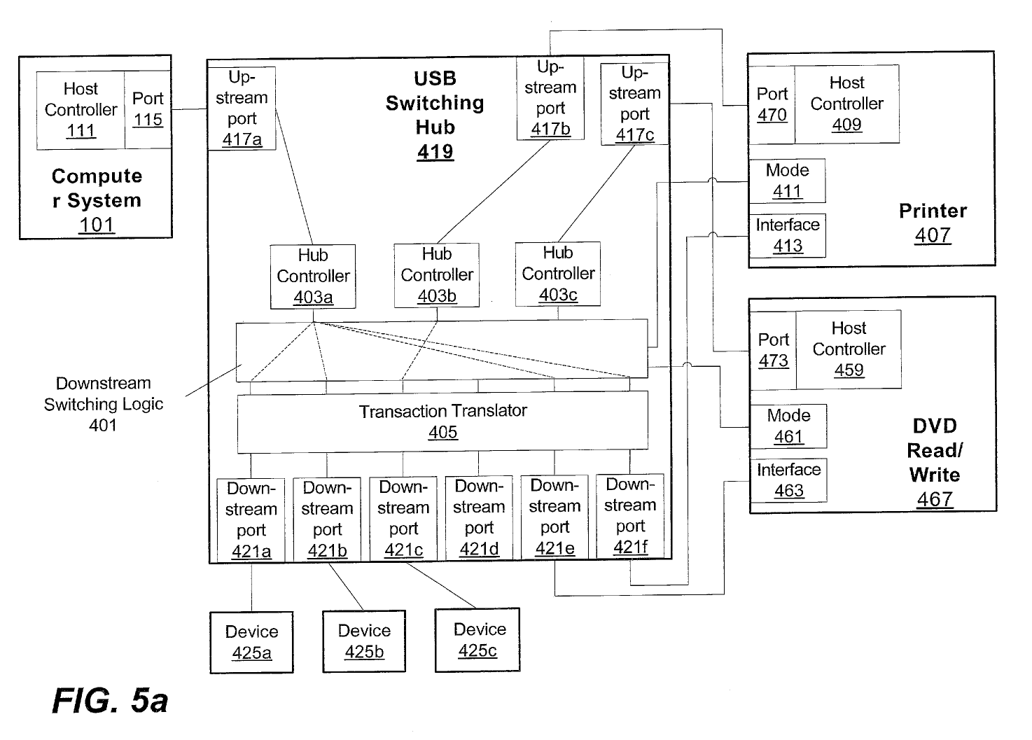

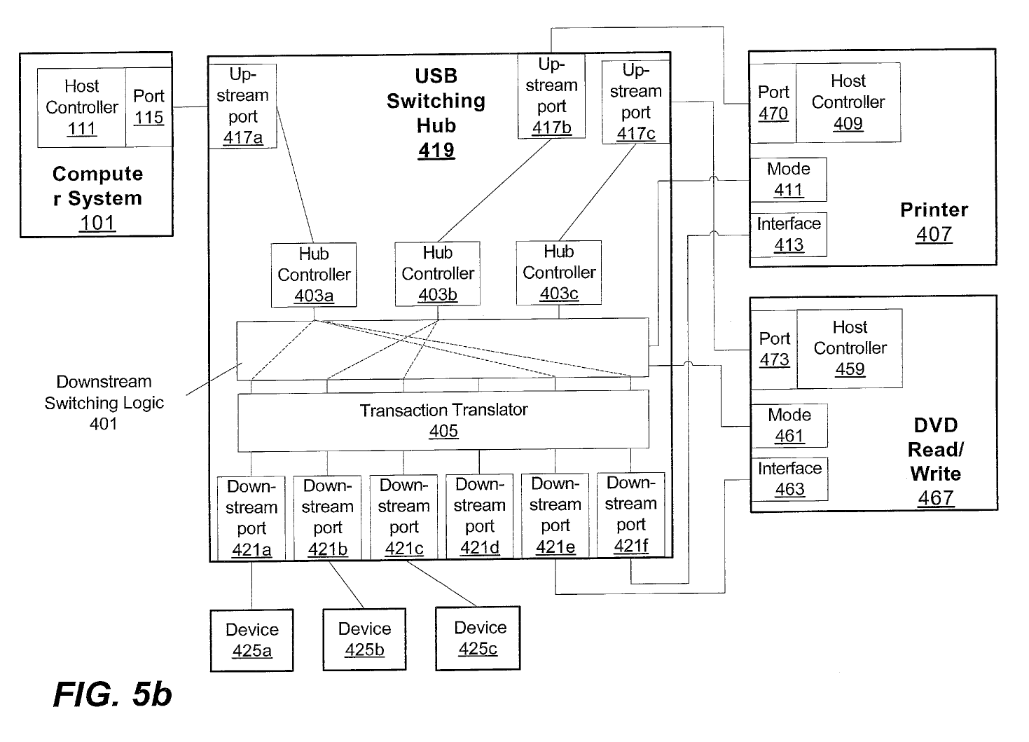

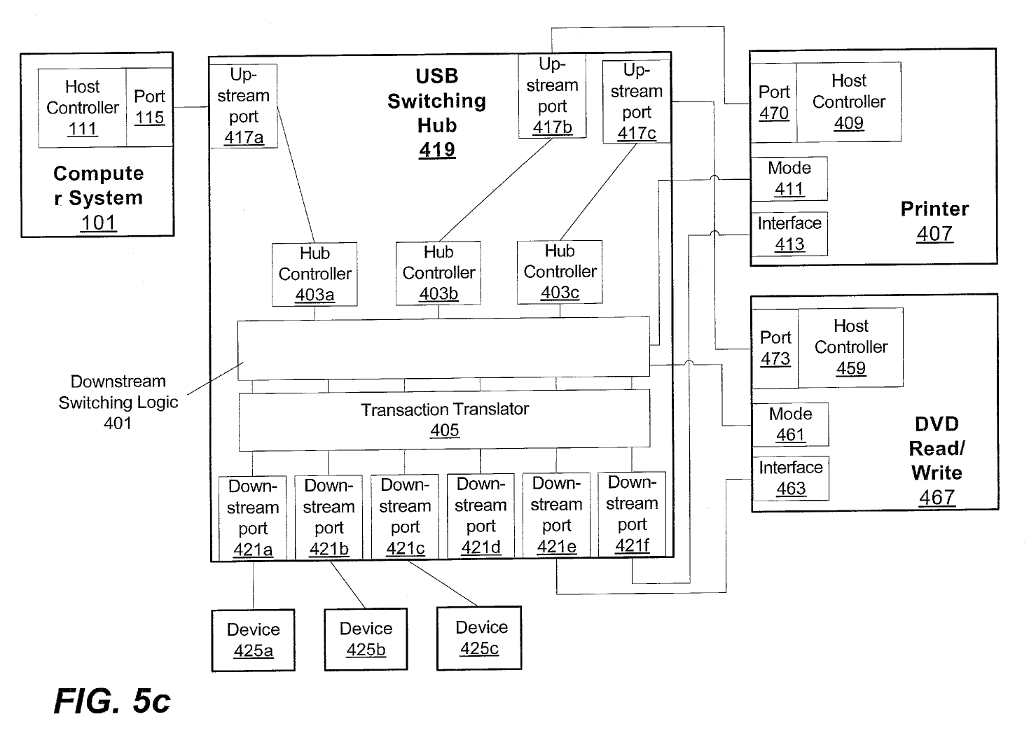

FIGS. 5a, 5b, and 5c illustrate various embodiments of computer system 101 and two dual role peripheral devices coupled to USB switching hub 419. In some embodiments, multiple dual role peripheral devices may be coupled to USB switching hub 419. For example, dual role printer 407 may be coupled to USB switching hub 419 through upstream port 417b and dual role DVD read/write drive 467 may be coupled to USB switching hub 419 through upstream port 417c. Computer system 101 may be coupled to USB switching hub 419 through upstream port 417a. Each of the upstream devices may be coupled to a respective hub controller 403, downstream switching logic 401, and transaction translator 405. Downstream switching logic 401 may configure communications between each of the upstream devices (i.e., computer system 101, dual role printer 407, or dual role DVD read/write drive 467) and at least a subset of the peripheral devices 425.

As seen in FIG. 5a, in one communication configuration profile, the computer system 101 may be connected to downstream ports 421a, 421b, 421e, and 421f. In an embodiment, dual role printer 407 may be configured to access downstream port 421c, and DVD read/write drive 467 may be configured not to access any downstream port 421. Dual role printer 407 may gain access (i.e., have the communication configuration switched to give it access) to downstream port 421b through several different methods. For example, a user may press a button on dual role printer 407. A signal may then be sent through mode 411 to downstream switching logic 401 in USB switching hub 419. Downstream switching logic 401 may switch to the communication configuration seen in FIG. 5b (which allows dual role printer 407 to access downstream port 421b). In some embodiments, if dual role printer 407 is turned off or becomes inactive, downstream switching logic 401 may switch access of downstream port 421b back to computer system 101 (i.e., switch back to the previous communication configuration). As seen in FIG. 5c, in one communication configuration, none of the upstream ports may be allowed to access any of the downstream ports.

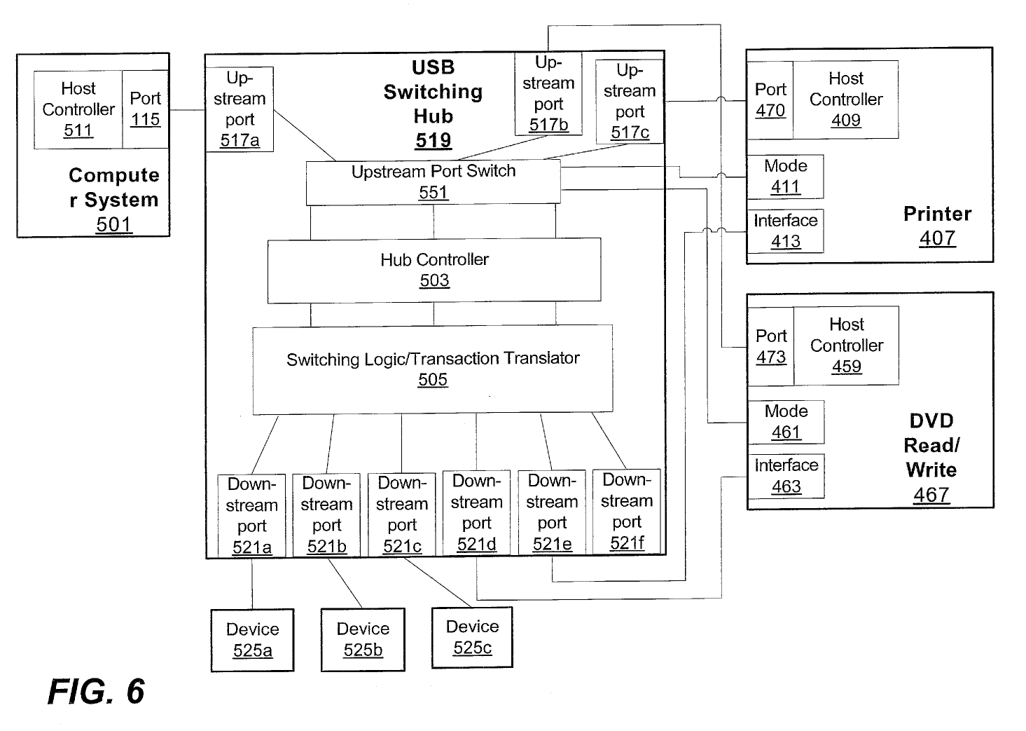

FIG. 6 illustrates an embodiment of unified functions within the USB switching hub. In some embodiments, instead of separate hub controllers, unified hub controller 503 may be used. For example, instead of separate hub controllers handling communications for their respective upstream port, a unified hub controller may handle communications for each of the upstream ports. Similarly, unified transaction translator 505 may be used for each respective upstream port. Also, as seen in FIG. 6, in some embodiments, an upstream port switch may be used. For example, the upstream port switch may implement various communication configurations instead of a downstream switching logic.

In some embodiments, transaction translator(s) in the USB switching hub (e.g., USB switching hub 419 or USB switching hub 519) may allow upstream ports to communicate at different communication speeds relative to the other upstream ports. For example, one upstream port may be coupled only to high speed devices and, therefore, communicate at high speed, while a separate upstream port may be coupled to only full speed devices and, therefore, communicate at full speed. In some embodiments, upstream ports may be able to communicate with different downstream ports at different speeds because of the transaction translators.

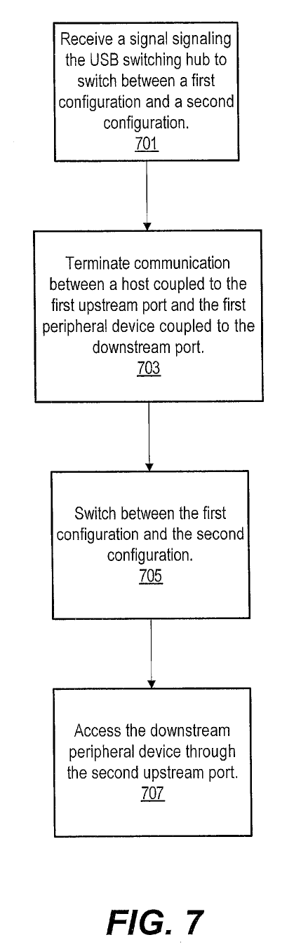

FIG. 7 shows an embodiment of a method for switching access to a downstream port between two upstream ports on the USB switching hub. It should be noted that in various embodiments of the methods described below, one or more of the elements described may be performed concurrently, in a different order than shown, or may be omitted entirely. Other additional elements may also be performed as desired.

At 701, the USB switching hub may receive a signal (e.g., an external control signal) signaling the USB switching hub to switch between a first communication configuration and a second communication configuration. For example, switching communication configurations may switch access of a first downstream port from a first upstream port to a second upstream port. In some embodiments, a user may press a button on a dual role peripheral device coupled to the USB switching hub, and the dual role peripheral device may send an external control signal to the USB switching hub to signal the USB switching hub to switch between one or more communication configurations. In some embodiments, the signal may be internal (e.g., generated by logic internal to the USB switching hub).

At 703, communication between a host coupled to the first upstream port and the first peripheral device coupled to the first downstream port may be terminated. In some embodiments, communication may be terminated for a subset of the downstream peripheral devices.

At 705, the USB switching hub may switch between the first communication configuration and the second communication configuration to give access of the first downstream port to the second upstream port. In some embodiments, the communication configuration switch may affect access for a subset of the downstream peripheral devices.

At 707, the downstream peripheral device coupled to the first downstream port may be accessed through the second upstream port by the host coupled to the second upstream port. In some embodiments, the second upstream port may communicate with a subset of the downstream peripheral devices. For example, the host may enumerate and then communicate with the switched multiple downstream devices. In some embodiments, access between the first upstream port and a second downstream port may continue.

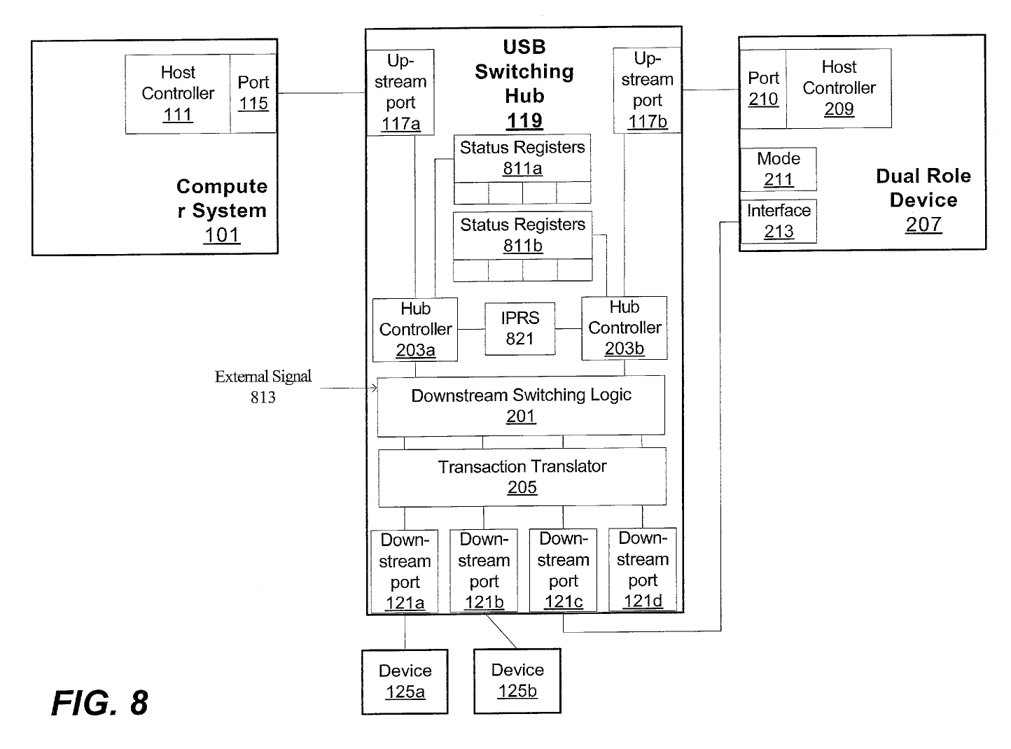

FIG. 8 illustrates a USB switching hub with multiple status registers, according to an embodiment. In some embodiments, upstream devices (e.g., computer system 101 and dual role device 207) may communicate with downstream devices 125 through downstream ports 121. In some embodiments, each upstream device may enumerate USB switching hub 119 as a 4-port hub (or according to the number of downstream ports 121 on the USB switching hub 119). In some embodiments, external signal 813 may signal downstream switching logic 201 to switch communications for a subset of downstream ports 121 (e.g., downstream ports 121a and 121b). When communications are being switched, a status register (e.g., a status register in a set of status registers 811a) may indicate a disconnect status for the previously connected downstream port). In some embodiments, communications between the downstream port and the second upstream device may then be established. For example, activity from downstream port 121a may indicate a connect event on a status register for downstream port 121a in the second set of status registers 811b. The second upstream device (e.g., dual role device 207) may detect the “connect” event when it poles status registers 811b and then reset the device coupled to downstream port 121a. While the second upstream device is communicating through downstream port 121a, other upstream devices coupled to other upstream ports may detect a “disconnect” for downstream port 121a when they poll their respective set of status registers 811.

In some embodiments, intelligent port routing switch (IPRS) 821 may delay switching communications for downstream port 125a if there is an active transfer in progress between downstream port 125a and first upstream port 117a. In some embodiments, IPRS 821 may delay switching communications for downstream port 125a if there is an active transfer in progress between downstream port 125 and second upstream port 117b. In some embodiments, IPRS 821 may be implemented in hardware and/or firmware on USB switching hub 119. In some embodiments, the IPRS may be implemented in software on computer system 101. The IPRS may include software and drivers that have knowledge of current USB traffic to delay a request to switch a device that is in use. In some embodiments, the IPRS may be entirely outside of any traffic monitoring internal to USB switching hub 119.

IPRS 821 may delay switching communications between other downstream ports 125 if there are pending or active transfers in progress. In some embodiments, IPRS 821 may monitor communications at the hub controller 203 level or may monitor communications at the downstream switching logic level. Other placements between downstream ports 121 and upstream ports 117 may also be used. In some embodiments, instead of relying on intelligent monitoring or an external method for delaying switching communications, IPRS 821 may operate to delay switching such that switching takes place at the USB frame boundary (when, by definition, no traffic is permitted to be in progress). In such embodiments, switching may be delayed until the frame boundary on a predetermined basis, not as a result of intelligent monitoring. The USB frame boundary may be the USB EOF2 (end of frame 2) boundary.

In some embodiments, external signal 813 (e.g., from a user, from computer system 101, or from mode 211 on dual role device 207) may signal downstream switching logic 201 to switch communications between a downstream port 121 and the upstream ports 117. Other sources of external signal 813 are also contemplated (e.g., the external signal may originate from a physical switch coupled to USB switching hub 119). In some embodiments, the physical switch may have switches, push buttons and/or other mechanical components to allow a user to assign one or more downstream ports 121 to specific upstream port 117. In some embodiments, external signal 813 may be sent from computer system 101. For example, an application executing on computer system 101 may allow a user to interact with computer system 101 to assign one or more downstream ports 121 to specific upstream port 117. In some embodiments, computer system 101 may also receive signals back from USB switching hub 119 to communicate with the user. For example, if there are transfers between a related downstream port and an upstream port, USB switching hub 119 may communicate this status to the user, and USB switching hub 119 may wait until it receives confirmation from the user to proceed with the switch (e.g., a signal may be sent from computer system 101 confirming the switch after a user selects a graphical “Proceed” box on a computer screen coupled to computer system 119.)

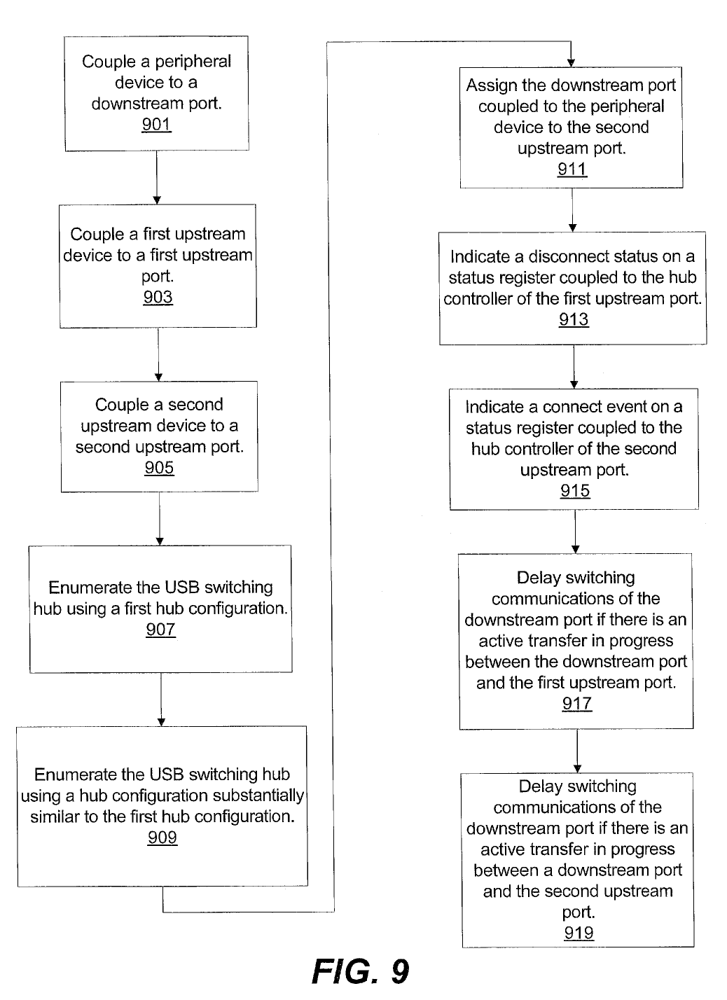

FIG. 9 shows an embodiment of a method for switching access to downstream port 121 between two upstream ports without reenumerating USB switching hub 119. It should be noted that in various embodiments of the methods described below, one or more of the elements described may be performed concurrently, in a different order than shown, or may be omitted entirely. Other additional elements may also be performed as desired.

At 901, a peripheral device may be coupled to a downstream port of a USB switching hub. In some embodiments, the peripheral device may be a USB device. The USB device may also be coupled to an upstream device (i.e., the USB device may be a dual role USB device).

At 903, a first upstream device may be coupled to first upstream port 117a of the USB switching hub 119.

At 905, a second upstream device may be coupled to second upstream port 117b of USB switching hub 119.

At 907, the first upstream device may enumerate USB switching hub 119 using a first hub configuration for USB switching hub 119. For example, if USB switching hub 119 has four downstream ports 121, the first upstream device may enumerate USB switching hub 119 as a 4-port hub. In some embodiments, the first upstream device may enumerate USB switching hub 119 with fewer downstream ports 121 than the total number of downstream ports 121 on USB switching hub 119 (e.g., if one or more downstream ports 121 is permanently inactive or reserved for another use).

At 909, the second upstream device may enumerate USB switching hub 119 using a hub configuration substantially similar to the first hub configuration for USB switching hub 119.

At 911, the downstream port coupled to the peripheral device may be assigned to the second upstream port. In some embodiments, communications between the peripheral device and the first upstream port may be switched to the second upstream port. In some embodiments, if device 125a is a digital camera, it may be initially coupled to computer system 101 (i.e., communications to/from the digital camera may be routed to first upstream port 117a in downstream switching logic 201 while the communications are in the digital domain). External signal 813 (e.g., from a user through computer system 101) may signal downstream switching logic 201 to switch communications between device 125a and two upstream ports 117.

At 913, a disconnect status may be indicated on a status register, corresponding to the switched downstream port, coupled to hub controller 203a of first upstream port 117a. Communications may be terminated between downstream device 125a and an upstream device coupled to first upstream port 117a.

At 915, a connect event may be indicated on a status register, corresponding to the switched downstream port, coupled to hub controller 203b of second upstream port 117b. When second upstream device 207 (e.g., a dual role printer) reads the connect event on the status register, it will reset device 125a coupled to downstream port 121a. Downstream device 125a may connect to upstream device 207 for further communications (e.g., to print pictures directly from the digital camera).

At 917, switching communications of a downstream port 121 may be delayed if there is an active transfer in progress between a downstream port 121 and the first upstream port. Switching communications may be delayed by IPRS 821.

At 919, switching communications of a downstream port 121 may be delayed if there is an active transfer in progress between a downstream port 121 and second upstream port 117b. Switching communications may be delayed by IPRS 821.

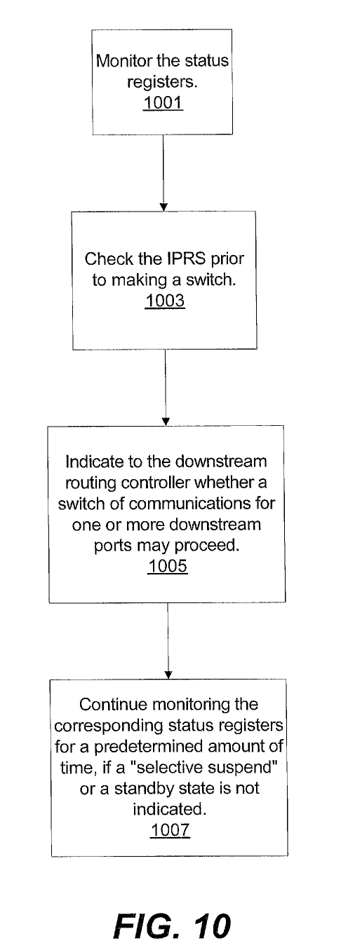

FIG. 10 shows an embodiment of a method for monitoring a standby state to approve a communication switch. It should be noted that in various embodiments of the methods described below, one or more of the elements described may be performed concurrently, in a different order than shown, or may be omitted entirely. Other additional elements may also be performed as desired.

At 1001, IPRS 821 may monitor status registers 811 to determine if peripheral device 125 is actively being used by an upstream device. For example, IPRS 821 may determine if a corresponding status register has a “selective suspend” or a standby state indicated for corresponding downstream port 121.

At 1003, downstream switching logic 201 may check IPRS 821 prior to making a switch for an indication as to whether there are current communications between a downstream port 121 to be switched or between downstream ports 121 coupled to upstream port 117 for which a downstream port 121 will be switched. In some embodiments, downstream switching logic 201 may query IPRS 821 to determine if multiple downstream ports 121 may be switched.

At 1005, IPRS 821 may indicate to downstream switching logic 201 whether a switch of communications for one or more downstream ports 121 may proceed. For example, logic on IPRS 821 may determine which downstream ports 121 the status should be checked (e.g., downstream ports 121 to be switched and downstream ports 121 coupled to the upstream port 117 being switched to). In some embodiments, IPRS 821 may check the corresponding status register when downstream switching logic 201 inquires as to a specific downstream port.

At 1007, if a “selective suspend” or a standby state is not indicated, IPRS 821 may continue to monitor the corresponding status register for a predetermined amount of time after IPRS 821 receives an inquiry from downstream switching logic 201 that a switch is desired. At the end of the predetermined amount of time, if the “selective suspend” or a standby state is still not indicated, IPRS 821 may indicate to downstream port controller 201 that it may switch despite the apparent active status. In some embodiments, if the “selective suspend” or a standby state is not indicated, an indication may be sent to computer system 101 to ask the user if a switch should be made despite the apparent active status of one or more affected peripheral devices 125. If the user approves the switch, downstream switching logic 201 may proceed with the switch.

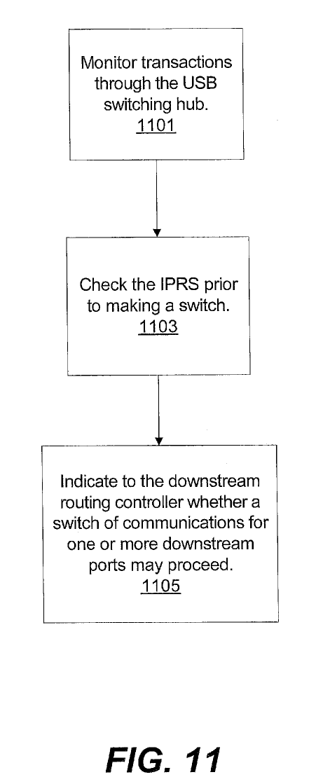

FIG. 11 shows an embodiment of a method for monitoring hub transactions to approve a communication switch. It should be noted that in various embodiments of the methods described below, one or more of the elements described may be performed concurrently, in a different order than shown, or may be omitted entirely. Other additional elements may also be performed as desired.

At 1101, IPRS 821 may monitor transactions through USB switching hub 119 to determine if any of the communications are going to/from relevant peripheral devices (e.g., coupled to a downstream port 121 to be switched or already coupled to upstream port 117 for which peripheral device 125 will be switched to). In some embodiments, the presence of communications and the type of communications may be monitored by IPRS 821. IPRS 821 may monitor communications at any of various points of USB switching hub 119 (e.g., coupled to hub controllers 203, downstream switching logic 201, and/or coupled directly to downstream ports 121 and/or upstream ports 117). IPRS 821 may monitor communications using additional internal logic. In some embodiments, IPRS 821 may not interfere with communications between downstream ports 121 and upstream ports 117.

At 1103, downstream switching logic 201 may check IPRS 821 prior to making a switch for an indication as to whether there are current communications between a downstream port 121 to be switched or between downstream ports 121 coupled to upstream port 117 for which a downstream port 121 will be switched.

At 1105, IPRS 821 may indicate to downstream switching logic 201 whether a switch of communications for one or more downstream ports 121 may proceed.

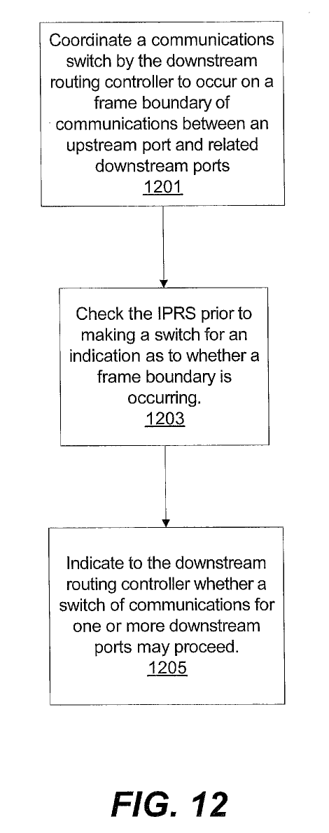

FIG. 12 shows an embodiment of a method for switching communications at a frame boundary. It should be noted that in various embodiments of the methods described below, one or more of the elements described may be performed concurrently, in a different order than shown, or may be omitted entirely. Other additional elements may also be performed as desired.

At 1201, IPRS 821 may coordinate a communications switch by downstream switching logic 201 to occur on a frame boundary of communications between upstream port 117 and related downstream ports 121. In some embodiments, IPRS 821 may interface with one or more hub controllers 203 to determine the timing of the frame boundaries. For example, a microframe timer may be used. In some embodiments, IPRS 821 may interface with other parts of USB switching hub 119 to determine a time to affirm a request to switch from downstream switching logic 201.

At 1203, downstream switching logic 201 may check IPRS 821 prior to making a switch for an indication as to whether a frame boundary is occurring for communications to/from the relevant downstream ports 121.

At 1205, IPRS 821 may indicate to downstream switching logic 201 whether a switch of communications for one or more downstream ports 121 may proceed.

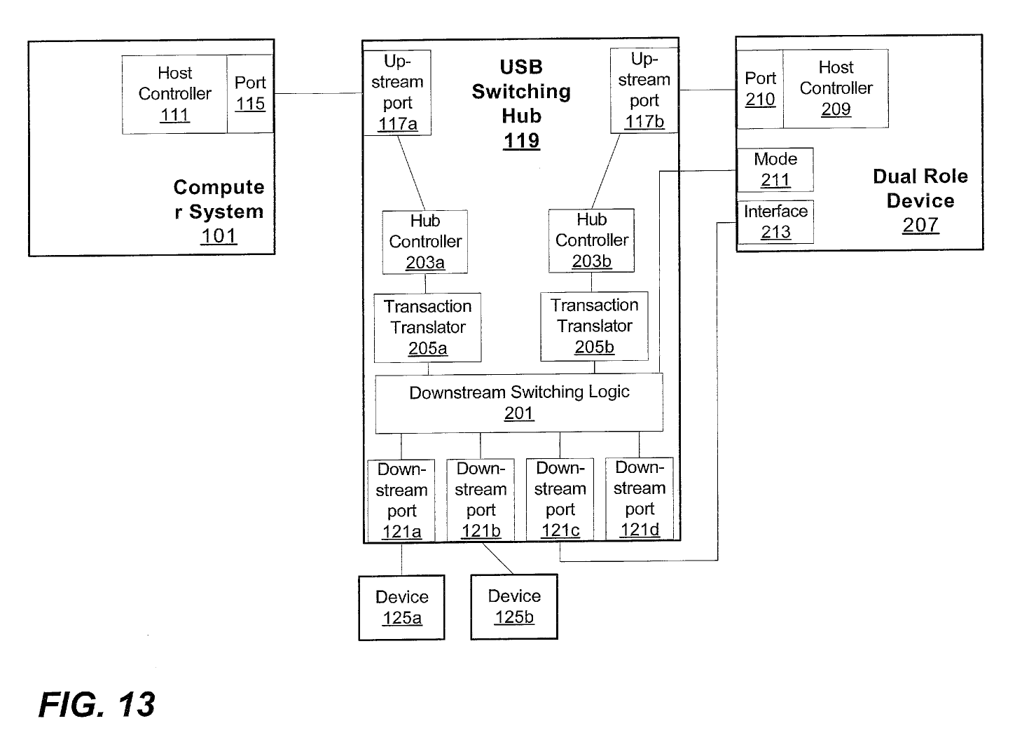

Referring again to FIGS. 3, 4a-4b, 5a-5c, and 8, it should be noted that the positions of the downstream switching logic (201 in FIGS. 3, 4a-4b and 8, and 401 in FIGS. 5a-5c) and the transaction translator logic (205 in FIGS. 3, 4a-4b and 8, and 405 in FIGS. 5a-5c) with respect to each other may be reversed, that is, the transaction translator logic may be configured between the hub controller(s) and the downstream switching logic. Furthermore, an individual transaction translator block may be configured for each upstream port (and corresponding hub controller.) Examples of alternate embodiments showing this configuration are found in FIGS. 13, 14a-14b, 15a-15c, and 16.

FIG. 13 illustrates an alternate embodiment of the configuration shown in FIG. 3, in which two upstream devices (e.g., computer system 101 and dual role peripheral device 207) are coupled to USB switching hub 119. In some embodiments, USB switching hub 119 may include respective transaction translator circuitry 205a and 205b for each upstream port 117a and 117b, coupled to corresponding hub controller 203a and 203b, respectively. Transaction translator circuitry 205a and 205b may also be coupled to downstream switching logic 201, which may be electronically coupled to downstream ports 121. In some embodiments, downstream switching logic 201 may switch between two or more communication configurations. Communication configurations may be implemented by downstream switching logic 201 routing communications between upstream ports 117 and downstream ports 121 while the communications are in the digital domain (as a result of the interfaces to/from USB switching hub 119), as also described for the embodiment of FIG. 3. In some embodiments, communication configurations (e.g., hardwired in the USB switching hub) may be switched as determined by logic on the USB switching hub. Other communication configuration implementations are also contemplated.

As also described for the embodiment of FIG. 3, in some embodiments, dual role peripheral device 207 may include a dual role USB printer or dual role USB Digital Versatile Disc (DVD) read/write drive, among others. In some embodiments, dual role peripheral device 207 may be coupled to an upstream port (e.g., upstream port 117b) of USB switching hub 119 through device port 210. Dual role peripheral device 207 may interface through upstream port 117b with other peripheral devices (downstream peripheral devices) coupled to USB switching hub 119 (e.g., using host controller 209 on dual role peripheral device 207). Dual role peripheral device 207 may also interface with other upstream devices (such as computer system 101) through a slave controller. For example, dual role peripheral device 207 may be coupled to USB switching hub 119 as a slave peripheral device (e.g., through downstream port 121c). In some embodiments, dual role peripheral device 207, coupled to the USB switching hub, may simultaneously act as a host to one or more peripheral devices and/or as slave peripheral device to a separate host.

In some embodiments, dual role peripheral device 207 may have an embedded host controller application to operate as a standalone system (e.g., to communicate with another peripheral device, such as a digital camera, without PC intervention). For example, a dual role USB printer may print pictures directly from a digital camera, coupled to a downstream port 121 on USB switching hub 119, without PC intervention. In some embodiments, USB switching hub 119 may alternately allow the computer system 101 or dual role peripheral device 207 to access one or more downstream devices (e.g., by switching between one or more communication configurations).

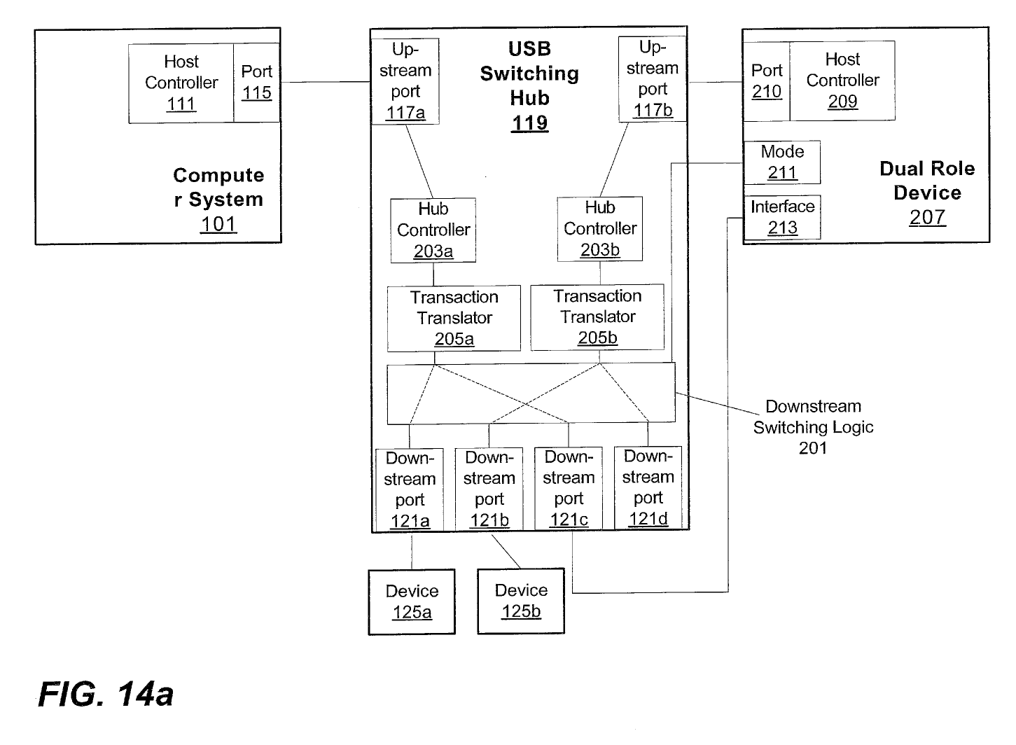

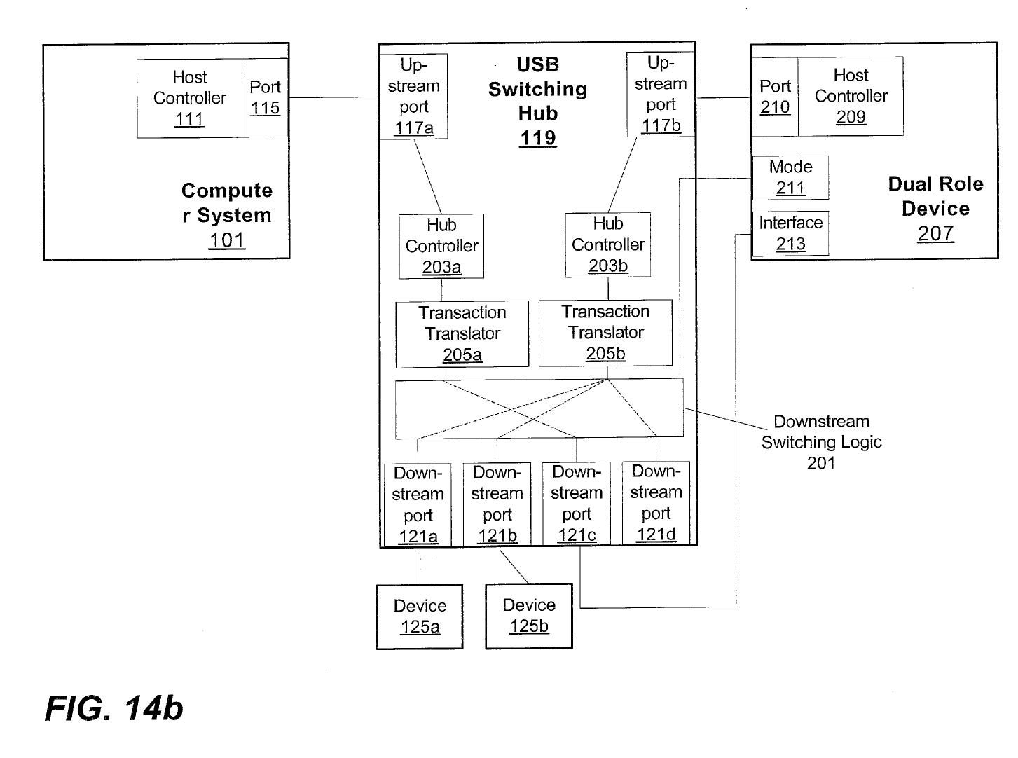

FIGS. 14a and 14b illustrate alternate embodiments of the embodiments shown in FIGS. 4a and 4b of a computer system electronically coupled to multiple peripheral devices. In some embodiments, USB switching hub 119 may act like a switch coupling multiple internal “hubs” that may share one or more downstream ports. For example, each potential communication configuration of the USB switching hub may represent an internal “hub”. In some embodiments, when computer system 101 is accessing peripheral device 125 (e.g., peripheral device 125a) coupled to USB switching hub 119, communications to/from the peripheral device may be processed through a first “hub” comprised of first upstream port 117a, hub controller 203a, transaction translator 205a, and at least a subset of the downstream ports 121. A second “hub” may be comprised of second upstream port 117b, hub controller 203b, transaction translator 205b, and at least a subset of the downstream ports 121. In one communication configuration, computer system 101 may connect to downstream ports 121a and 121c (through the first “hub”), and dual role peripheral device 207 may connect to downstream ports 121b and 121d (through the second “hub”) (as seen in FIG. 14b). Other communication configurations are also contemplated. In some embodiments, communication configuration profiles designating which downstream devices to couple to each upstream port may be hardwired or implemented by software. For example, if implemented by software, communication configuration profiles for each upstream port (and/or upstream device) may be stored on a memory accessible to USB switching hub 119.

In some embodiments, computer system 101 and dual role peripheral device 125 may communicate through USB switching hub 119 simultaneously with separate downstream devices. For example, while computer system 101 communicates with device 125a (e.g., through the first “hub”), dual role peripheral device 207 may communicate with device 125b (e.g., through the second “hub”). In some embodiments, while peripheral device 125a is being accessed through the first “hub”, a different upstream device may not be able to access peripheral device 125a (e.g., dual role peripheral device 207 may not be able to access peripheral device 125a while peripheral device 125a is being used by computer system 101). In some embodiments, a signal (e.g., from an external control block) may trigger downstream switching logic 201 to switch access for a subset of downstream ports 121 (e.g., downstream port 121a and/or 121c) on the first “hub” to the second “hub” (i.e., switch communication configurations). In some embodiments, dual role peripheral device 207 may send a control signal to USB switching hub 119. USB switching hub 119 may then switch communication configurations to connect one or more downstream ports to the dual role peripheral device. For example, when a user presses a button on dual role peripheral device 207 (e.g., a dual role printer), a signal may be sent through mode 211 to downstream switching logic 201 to switch access of device 125a from computer system 101 to dual role peripheral device 207 (i.e., to switch to a second communication configuration as seen in FIG. 14b). Computer system 101 may continue to communicate with downstream port 121c (and/or other downstream ports as determined by the second communication configuration).

In some embodiments, when activity is no longer detected between dual role peripheral device 207 and a downstream port (e.g., if dual role peripheral device 207 is turned off), downstream switching logic 201 may switch access of the downstream port to computer system 101 (i.e., switch to a different communication configuration). In some embodiments, downstream switching logic 201 may switch access of the downstream port to a different upstream device. In some embodiments, instead of detecting inactivity, a signal from dual role peripheral device 207 may signal USB switching hub 119 to switch. Other signals and/or logic may also be used in determining when to switch communication configurations.

In some embodiments, communication configurations may be software implemented. In some embodiments, a microprocessor coupled to or comprised in downstream switching logic 201 may dynamically determine, e.g., using a dynamic communication configuration profile, which downstream ports to electrically couple to each upstream port. For example, the microprocessor may read a stored communication configuration profile and attempt to connect upstream ports to downstream ports according to the communication configuration profile. The communication configuration profiles may be stored on a memory (e.g., an Electronically Erasable Programmable Read-Only Memory (EEPROM)) coupled to USB switching hub 119. In some embodiments, hub controllers 203 on USB switching hub 119 may have access to the communication configuration profiles.

In some embodiments, a priority logic may be used to switch communication configurations. Priority logic, or other logic used to grant access, may be internal or external to USB switching hub 119. In some embodiments, computer system 101 may be given priority over all of downstream ports 121 until an external control signal is sent from dual role peripheral device 207 to switch access of one or more downstream ports 121 to dual role peripheral device 207. In some embodiments, different control signals may be sent to trigger different communication configurations (i.e., to switch access of different downstream ports to dual role peripheral device 207).

In some embodiments, host negotiation logic may be used to determine which communication configuration to use. In some embodiments, a default communication configuration may be used until multiple upstream devices “request” access to the same downstream port. Host negotiation logic may be used to determine which communication configuration to use (i.e., which communication configuration gives a particular upstream port access to the “requested” downstream port).

In some embodiments, a microprocessor in USB switching hub 119 may include a built in algorithm that auto detects downstream peripheral devices and determines how to connect the downstream peripheral devices. For example, instead of assigning a specific downstream port to an upstream port, a communication configuration profile may specify that the upstream port should have access to a digital camera if one is attached. The built in algorithm may auto-detect the digital camera when it is attached to one of the downstream ports and attach it to the appropriate upstream port (i.e., by switching to an appropriate communication configuration).

In some embodiments, when downstream switching logic 201 switches communication configurations, and control of a downstream port is switched from computer system 101 to dual role peripheral device 207, a connection between computer system 101 and respective peripheral device 125 (coupled to the downstream port to be switched) may be terminated by computer system 101. In some embodiments, communications between the downstream port to be switched and computer system 101 may be terminated by USB switching hub 119. Dual role peripheral device 207 may then connect to, enumerate, and communicate with the respective peripheral device 125 coupled to the switched downstream port.

Upstream devices may see downstream ports that they are not configured to attach to as unattached ports (i.e., active, but with no device connected). In some embodiments, if only a predetermined number of downstream ports is ever going to be attached to a particular upstream port (e.g., a number “x” ports), the upstream device may be signaled that the hub only has x ports. For example, if upstream port 117b is only going to be configured to attach to downstream ports 121c and 121d, a device attached to upstream port 117b may be signaled that USB switching hub 119 is only a two port hub.

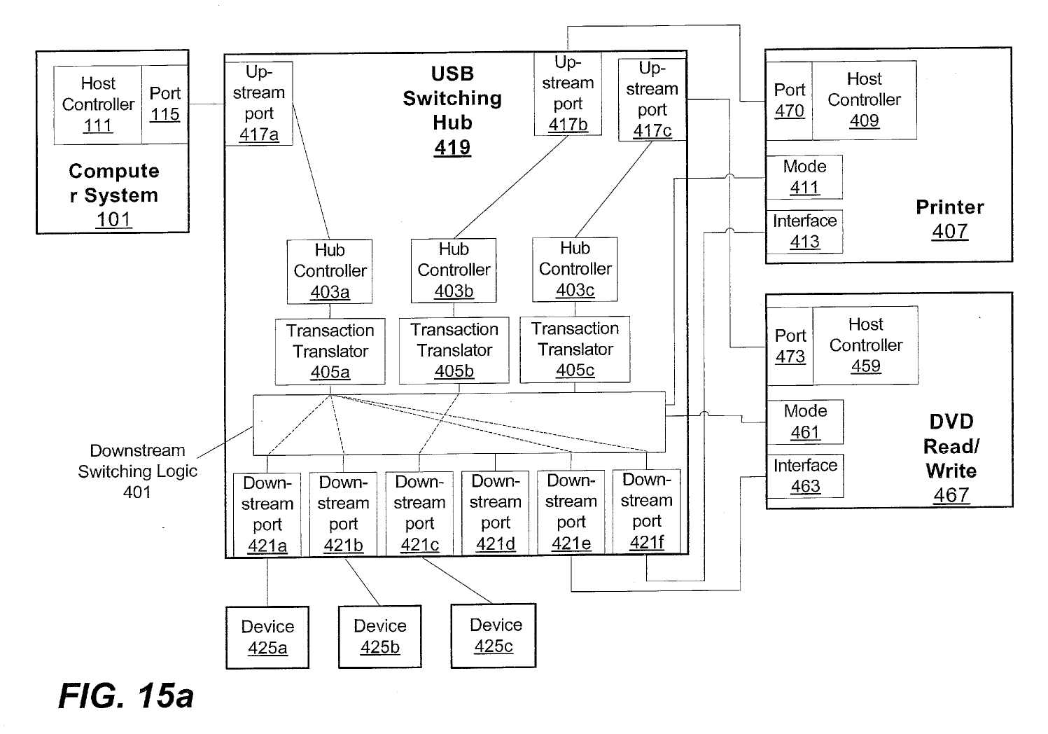

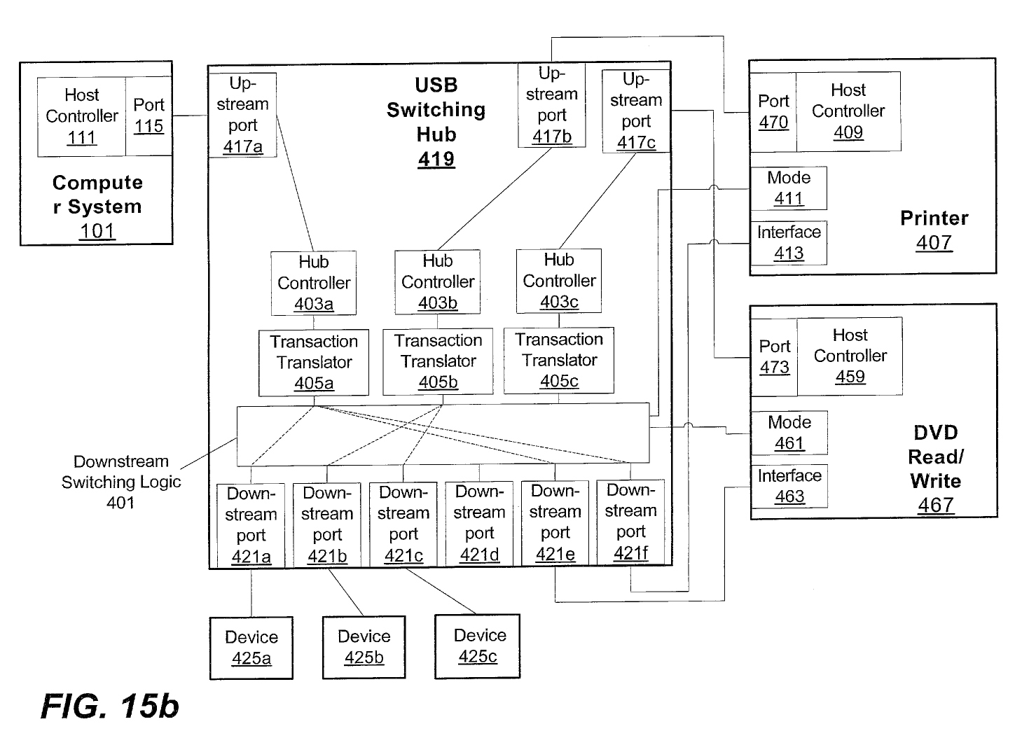

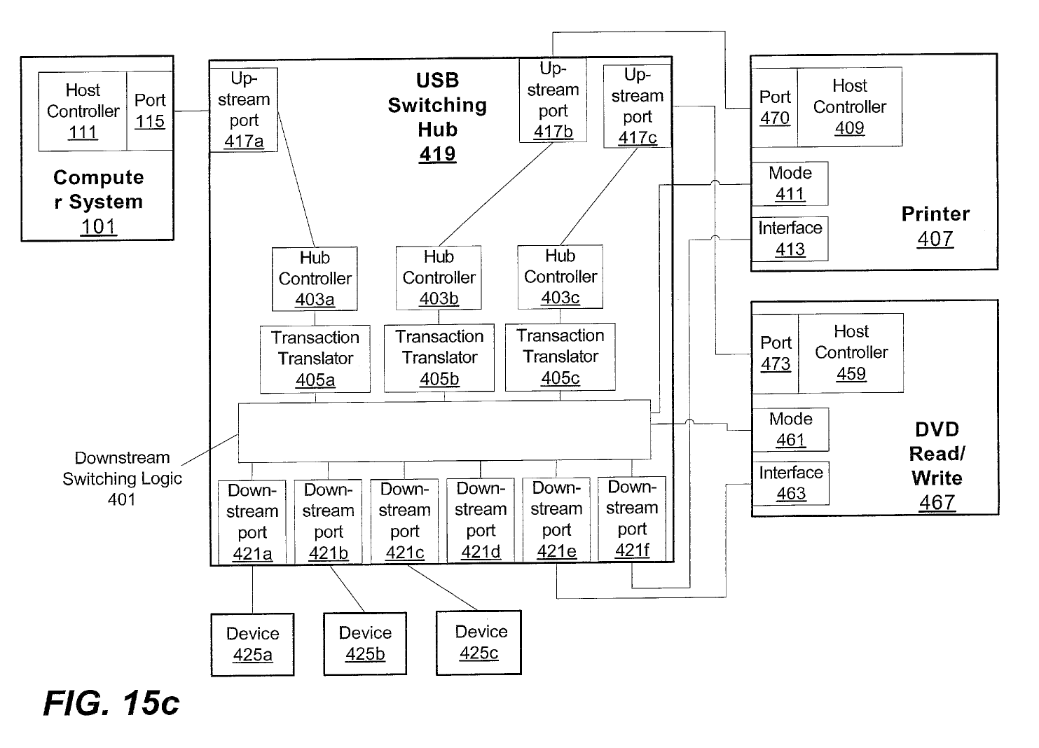

FIGS. 15a, 15b, and 15c illustrate various alternate embodiments of the embodiments shown in FIGS. 5a, 5b, and 5c of a computer system 101 and two dual role peripheral devices coupled to USB switching hub 419. In some embodiments, multiple dual role peripheral devices may be coupled to USB switching hub 419. For example, dual role printer 407 may be coupled to USB switching hub 419 through upstream port 417b and dual role DVD read/write drive 467 may be coupled to USB switching hub 419 through upstream port 417c. Computer system 101 may be coupled to USB switching hub 419 through upstream port 417a. Each of the upstream devices may be coupled to a respective hub controller 403 (403a, 403b and 403c, as shown), a respective transaction translator 405 (405a, 405b, and 405c, as shown), and downstream switching logic 401. Downstream switching logic 401 may configure communications between each of the upstream devices (i.e., computer system 101, dual role printer 407, or dual role DVD read/write drive 467) and at least a subset of the peripheral devices 425.

As seen in FIG. 15a, in one communication configuration profile, the computer system 101 may be connected to downstream ports 421a, 421b, 421e, and 421f. In an embodiment, dual role printer 407 may be configured to access downstream port 421c, and DVD read/write drive 467 may be configured not to access any downstream port 421. Dual role printer 407 may gain access (i.e., have the communication configuration switched to give it access) to downstream port 421b through several different methods. For example, a user may press a button on dual role printer 407. A signal may then be sent through mode 411 to downstream switching logic 401 in USB switching hub 419. Downstream switching logic 401 may switch to the communication configuration seen in FIG. 15b (which allows dual role printer 407 to access downstream port 421b). In some embodiments, if dual role printer 407 is turned off or becomes inactive, downstream switching logic 401 may switch access of downstream port 421b back to computer system 101 (i.e., switch back to the previous communication configuration). As seen in FIG. 15c, in one communication configuration, none of the upstream ports may be allowed to access any of the downstream ports.

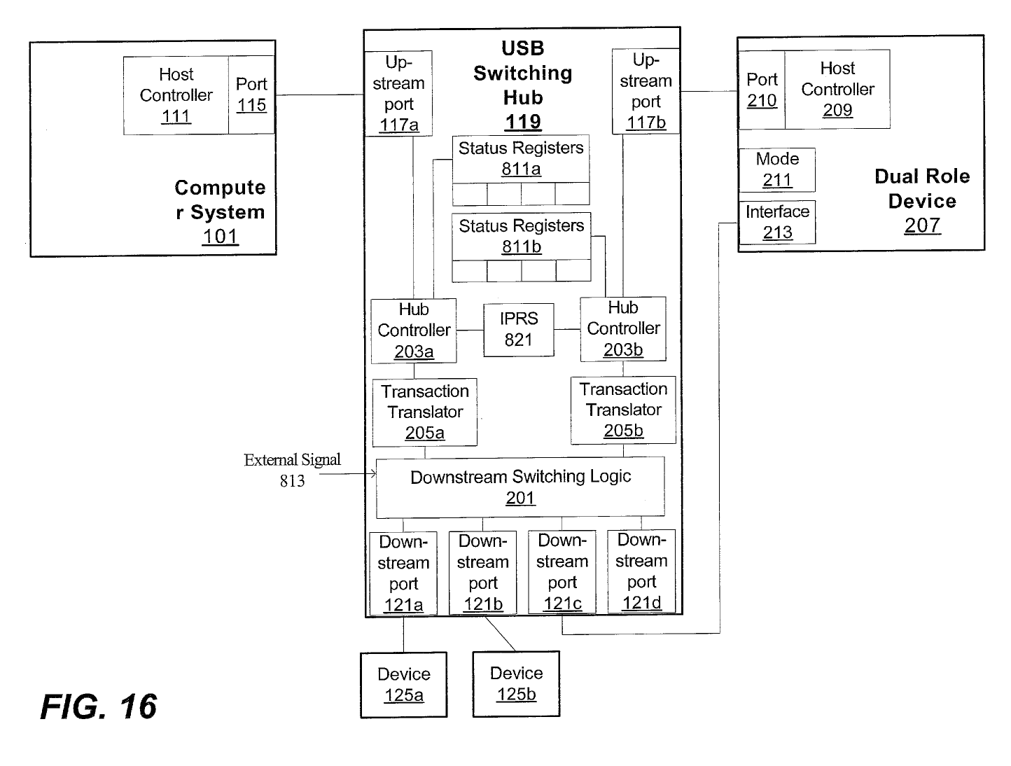

FIG. 16 illustrates an alternate embodiment of the USB switching hub with multiple status registers shown in FIG. 8. In this embodiment, each hub controller (203a and 203b) is coupled to corresponding transaction translator circuitry (205a and 205b, respectively). Translator circuitry 205a and 205b, may be coupled to downstream switching logic 201, which may be electrically coupled to downstream ports 121a, 121b, 121c, and 121d. Switching hub 119 may operate according to the same principles and procedures as described for the embodiment of switching hub 119 shown in FIG. 8.

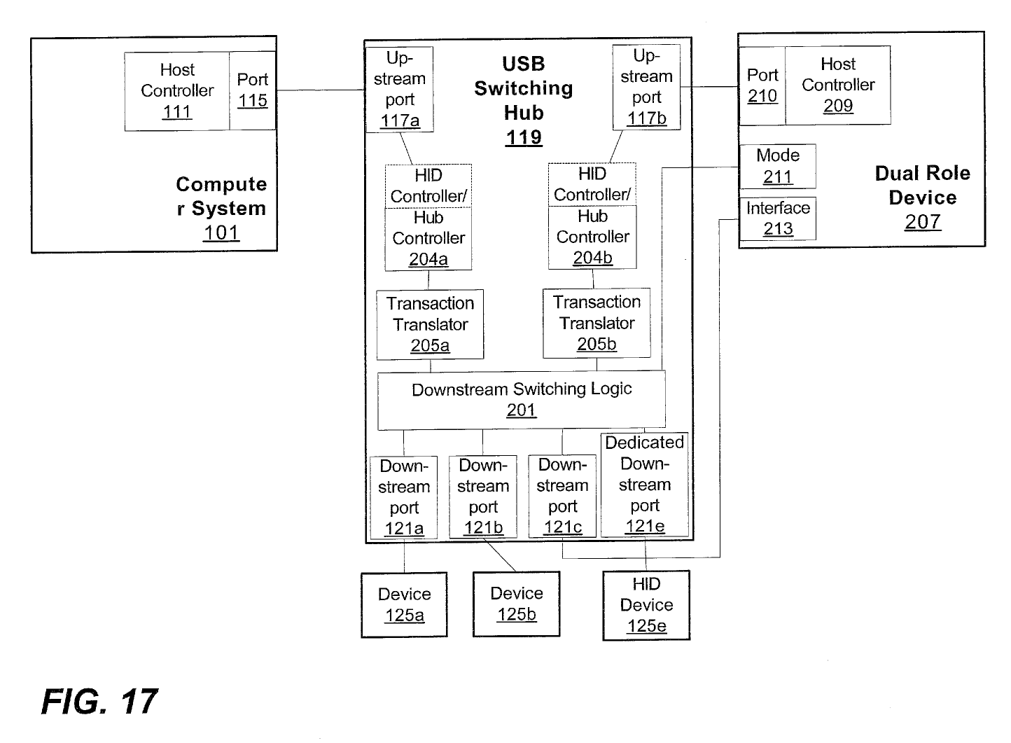

FIG. 17 illustrates another embodiment of the configuration shown in FIG. 13, in which two upstream devices (e.g., computer system 101 and dual role peripheral device 207) are coupled to USB switching hub 119. While in the embodiment of FIG. 13 (and in the embodiments of FIG. 3, FIGS. 4a-4b and FIGS. 14a-14b) the downstream control of USB switching hub 119 is linked with dual role device 207, alternate embodiments may be configured with other switching control means. For example, as illustrated in FIG. 17, switching control of USB switching hub 119 may be performed using a dedicated downstream device, for example HID class device 125e, coupled to a dedicated downstream port, for example dedicated downstream port 121e. Another control mechanism may comprise an additional HID device (not shown) configured at the hub controller level within the hierarchy of the configuration shown in FIG. 17. (for example at hub controller 203a or 203b). However, operating the additional HID device for controlling the switching of USB switching hub 119 may require custom drivers and a USB-IF class extension to the hub class, which may be covered under a vendor-specific implementation. Mechanisms other than an HID may also be possible with a semi-custom hub driver. Alternatively, a composite device comprising a hub controller and HID controller may be configured to control switching of USB switching hub 119, shown in FIG. 17 as HID controller/HUB controller composite devices 204a and 204b. While FIG. 17 illustrates a variety of configurations associated with possible control mechanisms for controlling switching of USB switching hub 119, various embodiments may include only one of, or any combination of these configurations and/or mechanisms.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A USB switching hub, comprising:
a plurality of upstream ports;
a plurality N of downstream ports; and
downstream switching logic coupled between the plurality of upstream ports and the plurality of downstream ports;
wherein the downstream switching logic is configured to electronically switch communications between:
a) a downstream port of the plurality of downstream ports and a first upstream port of the plurality of upstream ports to
b) the downstream port of the plurality of downstream ports and a second upstream port of the plurality of upstream ports;
wherein the USB switching hub is configured to be enumerated with a substantially similar hub configuration through each of the plurality of upstream ports;
wherein the hub configuration includes N downstream ports.

2. The USB switching hub of claim 1, wherein when communications are switched, upstream devices coupled to the first upstream port and the second upstream port are not required to re-enumerate the USB switching hub.

3. The USB switching hub of claim 1, wherein an upstream device coupled to the first upstream port or the second upstream port is operable to enumerate the USB switching hub with the total number of the plurality of downstream ports.

4. The USB switching hub of claim 1, further comprising a separate hub controller coupled to each of the plurality of upstream ports.

5. The USB switching hub of claim 4, further comprising a separate set of status registers coupled to each of the hub controllers.

6. The USB switching hub of claim 5,
wherein when communications for a peripheral device are switched, the peripheral device is disconnected from the first upstream port and a connect event is registered on a corresponding status register of the second upstream port;
wherein the corresponding status register is associated with a downstream port coupled to the peripheral device.

7. The USB switching hub of claim 6, further comprising an upstream device coupled to the second upstream port, wherein an upstream device coupled to the second upstream port attempts to reset the peripheral device being switched to the second upstream port upon reading the corresponding status register.

8. The USB switching hub of claim 4, wherein each hub controller is provided with the same hub configuration when the hub is initially enumerated.

9. The USB switching hub of claim 1, wherein the USB switching hub is configured to allow the plurality of upstream ports to simultaneously access separate downstream ports.

10. The USB switching hub of claim 1, further comprising an intelligent port routing switch coupled to the downstream switching logic.

11. The USB switching hub of claim 10, wherein the intelligent port routing switch delays switching communications of the downstream port if there is an active transfer in progress between the downstream port and the first upstream port.

12. The USB switching hub of claim 10, wherein the intelligent port routing switch delays switching communications of the downstream port if there is an active transfer in progress between the downstream port and the second upstream port.

13 The USB switching hub of claim 1, wherein the downstream switching logic is operable to delay switching communications of the downstream port to take place on a USB frame boundary, when by definition no traffic is permitted to be in progress.

14. The USB switching hub of claim 13, wherein the downstream switching logic is operable to delay switching communications of the downstream port to take place on a USB frame boundary on a predetermined basis.

15. The USB switching hub of claim 13, wherein the USB frame boundary is a USB EOF2 (end of frame 2) boundary.

16. A method, comprising:
coupling a peripheral device to a downstream port of a Universal Serial Bus (USB) switching hub;
coupling a first upstream device to a first upstream port of the USB switching hub;
coupling a second upstream device to a second upstream port of the USB switching hub;
the first upstream device enumerating the USB switching hub using a first hub configuration for the USB switching hub;
the second upstream device enumerating the USB switching hub using a hub configuration substantially similar to the first hub configuration for the USB switching hub; and
switching communications between the peripheral device and the first upstream port to the peripheral device and the second upstream port.

17. The method of claim 16, wherein the second upstream device is not required to re-enumerate the USB switching hub when communications are switched.

18. The method of claim 16, further comprising:
indicating a disconnect status on a status register, coupled to the first upstream port, for the switched downstream port.

19. The method of claim 16, further comprising:
indicating a connect event on a status register, coupled to the second upstream port, for the switched downstream port.

20. The method of claim 16, further comprising delaying switching communications of the downstream port if there is an active transfer in progress between the downstream port and the first upstream port, wherein switching communications is delayed by an intelligent port routing switch.

21. The method of claim 16, further comprising delaying switching communications of the downstream port if there is an active transfer in progress between a downstream port and the second upstream port, wherein switching communications is delayed by an intelligent port routing switch.

22. A system, comprising:
a USB switching hub, comprising:
a plurality of upstream ports;
a plurality of downstream ports;
downstream switching logic coupled between the plurality of upstream ports and the plurality of downstream ports;
a separate hub controller coupled to each of the plurality of upstream ports; and
a separate set of status registers coupled to each separate hub controller;
a plurality of upstream devices, wherein each one of the plurality of upstream devices is coupled to a respective one of the plurality of upstream ports of the USB switching hub;
wherein the USB switching hub is configured to be enumerated with a substantially similar hub configuration by each of the plurality of upstream devices coupled to its respective one of the plurality of upstream ports;
wherein switching communications between a subset of the plurality of downstream ports and a first upstream port of the plurality of upstream ports to a second upstream port of the plurality of upstream ports includes indicating a disconnect status on a status register coupled to the first upstream port's hub controller and indicating a connect event on the status register coupled to the second upstream port's hub controller.

23. The USB switching hub of claim 22, wherein a first upstream device of the plurality of upstream devices is coupled to the first upstream port and a second upstream device of the plurality of upstream devices is coupled to the second upstream port, wherein the first upstream device and the second upstream device do not have to re-enumerate the USB switching hub when communications between a subset of the plurality of downstream ports are switched from the first upstream port to the second upstream port.

24. The USB switching hub of claim 22, further comprising delaying switching communications of the subset of the plurality of downstream ports if there is an active transfer in progress between the downstream port and the first upstream port, wherein switching communications is delayed by an intelligent port routing switch.

25. The USB switching hub of claim 22, further comprising delaying switching communications of the subset of the plurality of downstream ports if there is an active transfer in progress between at least one downstream port of the subset of the plurality of downstream ports and the second upstream port, wherein switching communications is delayed by an intelligent port routing switch.
